(19) United States
(12) Patent Application Publication
(10) Pub. No.: US 2012/0118042 A1
(43) Pub. Date: May 17, 2012

(54) Photoacoustic Spectrometer with Calculable Cell Constant for Quantitative Absorption Measurements of Pure Gases, Gaseous Mixtures, and Aerosols

(76) Inventors: Keith A. Gillis, Washington Grove, MD (US); Daniel K. Havey, Harrisonburg, VA (US); Joseph T. Hodges, Washington Grove, MD (US)

(21) Appl. No.: 12/985,981

(22) Filed: Jan. 6, 2011

Related U.S. Application Data
(60) Provisional application No. 61/353,271, filed on Jun. 10, 2010.

(51) Int. Cl. G01N 21/84

(52) U.S. Cl. 73/24.02

(57) ABSTRACT

A photoacoustic spectrometer that is intensity-modulated, laser-driven and with a calculable cell constant. The axially symmetrical photoacoustic spectrometer combines first-principles models of acoustic wave propagation with high-resolution spectroscopic measurements, and takes into account molecular relaxation. The spectrometer includes a duct and two chambers disposed at the end of the duct. Inlet and exit tubes, which are disposed in substantially the location of acoustic pressure nodes, permit the gas, gaseous mixture or aerosol to enter and exit the spectrometer. The absolute response of the spectrometer may be modeled and measured. A detailed theoretical analysis of the system and its predicted response may be predicted as a function of gas properties, resonance frequency and sample energy transfer relaxation rates.

### CROSS-REFERENCE TO RELATED APPLICATIONS

The present application claims priority to provisional application Ser. No. 61/353,271, filed on or about Jun. 10, 2010, entitled “Photoacoustic Spectrometer with Calculable Cell Constant for Quantitative Absorption Measurements of Pure Gases, Gaseous Mixtures, and Aerosols” naming the same inventors as in the present application. The contents of this provisional application are incorporated by reference, the same as if fully set forth.

### STATEMENT REGARDING FEDERALLY SPONSORED RESEARCH/DEVELOPMENT

The subject matter of this patent application was invented by employees of the United States Government. Accordingly, the United States Government may manufacture and use the invention for governmental purposes without the payment of any royalties.

### BACKGROUND OF THE INVENTION

1. Field of Invention

The present disclosure relates to spectrometry and, more particularly, to a photoacoustic spectrometer for quantitative absorption measurements of pure gases, gaseous mixtures, and aerosols.

2. Description of Related Art

Optical techniques such as photoacoustic spectroscopy (hereinafter “PAS”) and direct absorption spectroscopy may be used for measuring the absorption coefficient of gases and aerosols. The absorption coefficient determines how far into a material light of a particular wavelength can penetrate before it is absorbed.

PAS techniques and direct absorption techniques differ in that direct absorption techniques measure the attenuation of a light beam, so there is a large background signal due to the incident beam. By contrast, PAS techniques involve an additional energy transfer mechanism, corresponding to the conversion of absorbed optical power to an acoustic wave whose amplitude may be measured with a microphone. There is no signal unless light is absorbed.

The acoustic properties of a PAS system do not depend upon the spectral distribution of the absorbed radiation. Accordingly, PAS devices may be broadband devices.

However, using a PAS technique, difficulties may arise in obtaining a robust prediction of absolute PAS system response over a wide range of gas composition, pressure and temperature. For example, conversion of the optical-to-acoustic energy may cause the acoustic signal to vary nonlinearly with absorber and buffer gas concentration.

There is a need for a PAS system that obtains a more robust prediction of absolute PAS system response over a wide range of gas composition, pressure and temperature.

PAS systems may be calibrated in terms of a reference sample of known absorption coefficient. PAS systems may be calibrated with the same probe laser and at the same wavelength as those employed for the measurements of interest without the need to disassemble the cell.

Efforts have been made to create a PAS system in which the known optical absorption properties of the oxygen (O₂) A-band are used to calibrate the response of a PAS system. However, prior art systems did not take into account the effect of molecular relaxation. Failure to account for the accompanying reduced conversion efficiency results in a large systematic error.

There is a need for a more accurate PAS system that accounts for reduced energy conversion efficiency associated with molecular relaxation.

### BRIEF SUMMARY OF DISCLOSURE

The present disclosure addresses the needs described above by providing a photoacoustic spectrometer, spectrometer system and method that combine first-principles models of acoustic wave propagation with high-resolution spectroscopic measurements. In accordance with one embodiment of the present disclosure, a photoacoustic spectrometer is provided. The spectrometer comprises a central duct having a length, a diameter, and an axis of symmetry along its length. The spectrometer also has two substantially identical cylindrical chambers configured to receive a gas, gaseous mixture or aerosol, each of said chambers having a length and a diameter. Each of the chambers is positioned at the end of the central duct and connected to each other by the central duct. The length of each said chambers is substantially equal to half the length of the central duct.

The chambers are axially symmetrical about the axis of symmetry for the central duct. The spectrometer also has an optical element mounted axially on an outer wall of each said two chambers, and a microphone positioned within the duct substantially midway between the two chambers, the microphone being configured to measure an acoustic response of a gas, gaseous mixture or aerosol when said gas, gaseous mixture or aerosol is disposed within the chambers and duct. The spectrometer also comprises an inlet tube extending from one of said two chambers, and an exit tube extending from the other of said two chambers, each of the inlet tube and exit tube being positioned at substantially the location of an acoustic pressure node.

In accordance with another embodiment of the present disclosure, a photoacoustic spectrometer system is provided. The system is a laser-driven and acoustically resonant photoacoustic spectrometer system. It includes a light source configured to emit light. It also includes a photoacoustic cell that has a central duct having a length, a diameter, and an axis of symmetry along its length. It also includes two substantially identical cylindrical chambers configured to receive a gas, gaseous mixture or aerosol, each of said chambers having a length and a diameter.

Each of the chambers is positioned at the end of the central duct and connected to each other by the central duct. The length of each said chambers is substantially equal to half the length of the central duct. The chambers are axially symmetrical about the axis of symmetry for the central duct. The cell also includes an optical element mounted axially on an outer wall of each said two chambers; an inlet tube extending from one of said two chambers, and an exit tube extending from the other of said two chambers. Each of the inlet tube and exit tube is positioned at substantially the location of an acoustic pressure node.

The system also includes a microphone positioned in the duct substantially midway between the two chambers, the microphone being configured to measure an acoustic response of a gas, gaseous mixture or aerosol when said gas, gaseous mixture or aerosol is disposed within the chambers and duct.

In accordance with yet another embodiment of the present disclosure, a method is provided for measuring the absolute response of a laser-driven, intensity modulated photoacoustic spectrometer. The method comprises the steps of emitting a laser beam from a light source. The method further comprises providing a photoacoustic cell that includes a central duct having a length, a diameter, and an axis of symmetry along its length. The cell also includes two substantially identical cylindrical chambers configured to receive a gas, gaseous mixture or aerosol.

Each of said chambers has a length and a diameter. Each of the chambers is positioned at the end of said central duct and connected to each other by the central duct. The length of each of the chambers is substantially equal to half the length of the central duct. The chambers are axially symmetrical about the axis of symmetry for the central duct. The photoacoustic cell that is provided also includes an optical element mounted axially on an outer wall of each said two chambers; an inlet tube extending from one of said two chambers, and an exit tube extending from the other of said two chambers. Each of the inlet tube and exit tube is positioned at substantially the location of an acoustic pressure node.

The method further comprises intensity modulating the laser beam and directing the beam to the photoacoustic cell; recording spectra; measuring the beam power exiting the photoacoustic cell; and calculating and measuring the absolute response of the photoacoustic cell.

These, as well as other objects, features and benefits will now become clear from a review of the following detailed description of illustrative embodiments and the accompanying drawings.

### BRIEF DESCRIPTION OF DRAWINGS

FIG. 1 is a schematic of a photoacoustic spectrometer in accordance with one embodiment of the present disclosure.

FIG. 2 is a graphical illustration of the measured sensitivity of the electret microphone of FIG. 1 under ambient conditions.

FIG. 3 is a graphical illustration of the absolute magnitude of the measured acoustic spectrum up to 5 kHz when the cell was filled with ambient air.

FIG. 4 is a graphical illustration of the measured response of the S1 mode in air for the spectrometer of FIG. 1.

FIG. 5 is a lumped-element acoustic circuit for the resonator shown in FIG. 1.

FIG. 6 is a graphical illustration of the measured and estimated resonance frequencies and quality factors for air and dry nitrogen.

FIG. 7 is a photoacoustic spectrometer system in accordance with one embodiment of the present disclosure.

### DETAILED DESCRIPTION OF THE DISCLOSURE

The present disclosure provides a photoacoustic spectrometer, as well as a method and system for calculating and measuring the absolute response of a laser-driven and acoustically resonant photoacoustic spectrometer. The photoacoustic spectrometer of the present disclosure combines first-principles models of acoustic wave propagation with high-resolution spectroscopic measurements.

Measurements associated with the photoacoustic spectrometer described herein exploit the well-known spectroscopic parameters of near-infrared magnetic dipole transitions of the oxygen (O₂) A-band.

The present disclosure describes a new axially symmetrical photoacoustic spectrometer, a spectrometer system and a method that may be adopted as a standard system suitable for laboratory and field measurements of absorption coefficients. The response of this spectrometer is modeled as a function of gas properties, resonance frequency and sample energy transfer relaxation rates. The present disclosure presents spectrally resolved PAS absorption measurements of O₂ A-band transitions in room temperature air over a wide range of humidity levels probed with a single-mode tunable, intensity-modulated, continuous-wave laser.

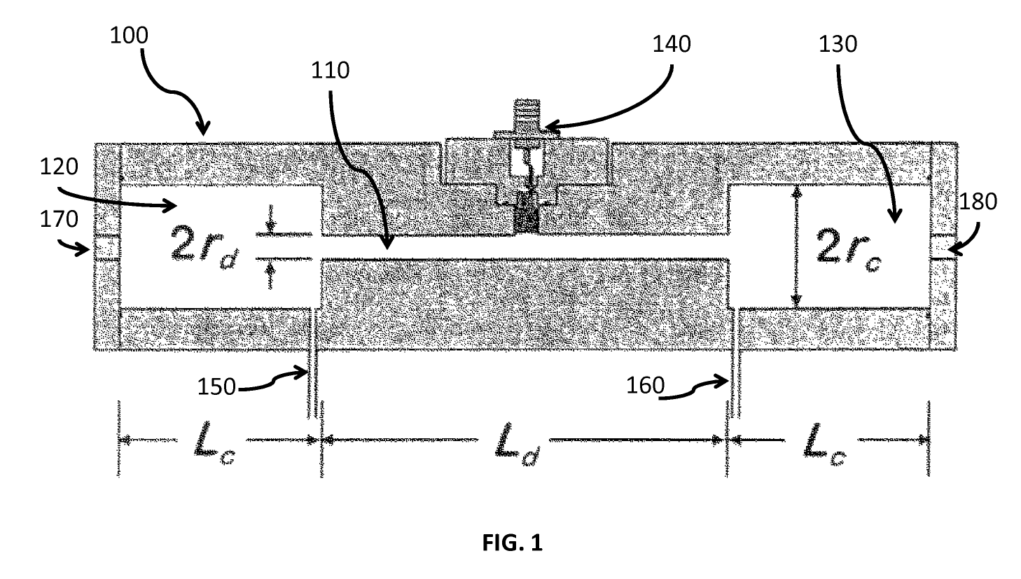

Referring now to FIG. 1, illustrated is a photoacoustic spectrometer in accordance with one embodiment of the present disclosure. As shown, the spectrometer includes a substantially cylindrical central duct 110 positioned between two substantially identical cylindrical chambers 120, 130. The length of chambers 120, 130 should be half the length of the duct 110. The diameter of either chamber 120 or 130 should be five times larger than the diameter of duct 110. In the present embodiment, the dimensions of the duct 110 and chambers 120, 130 are as follows: the central duct is about 100 millimeters (mm) long and 6 mm in diameter, while each chamber is about 50 mm long and 30 mm in diameter.

Optical elements 170, 180, may be planar windows or partially reflecting mirrors. These optical elements 170, 180, may be mounted axially in each of chambers 120, 130 on the outer walls. The spectrometer may be made of brass with leak-tight, indium-wire seals. Chambers 120, 130 and duct 110 are configured to receive gas, gaseous mixture or aerosols. Chambers 120, 130 may buffer a signal from either of windows 170 or 180. The length of either of chambers 120, 130 (Lₐ) and the length of duct 110 (L_{D}) may be chosen so as to optimize suppression interference or scattering from widows 170, 180.

Microphone 140 may be used to measure acoustic response. The microphone 140 may be an electret microphone, such as those commercially available through Knowles® under model number MD6052USZ-1. Microphone 140 may obviously be used as a sound detector. It may be located midway between the ends of the duct 110. At times the spectrometer 100, when without its microphone, is sometimes referred to herein as a photoacoustic cell.

Two small tubes 150, 160 may be used to flow gas into (inlet) and out of (exit) spectrometer 100. Tubes 150, 160 may be attached in each of chambers 120, 130 near the chamber's junction with the central duct 110. These junctions may be positioned near acoustic pressure nodes. At these nodes, the effect of a tube's admittance on the resonator's frequency response may be minimal. Plus, under steady flow conditions, an incoming gas, gaseous mixture or aerosol—for which the photoacoustic spectrometer is to measure its absorption coefficient—may be caused to mix thoroughly with the chamber gas since the flow velocity of the incoming gas may be as much as fourteen (14) times higher than the flow velocity of the main duct.

The spectrometer 100 shown in FIG. 1 may have multiple modes. For example, the one or more modes used for photoacoustic spectroscopy (PAS mode) may be non-degenerate and isolated from other modes. Also, the PAS mode(s) may couple more efficiently to the modulated laser intensity. Plus, the spectrometer response signal may be insensitive to synchronous optical absorption by the window and the spectrometer response may be insensitive to acoustic impedance of the gas-flow plumbing. Finally, the microphone 140 may have low noise and a smooth frequency response.

Central duct 110 may behave in a way similar to a half-wave resonator with open ends. It may be desirable to use only non-degenerate plane-wave modes for frequencies below the cut-off frequency for transverse modes. Longitudinal normal modes of an open-ended, half-wave resonator may occur when an integer number I of acoustic half-wavelengths fit between the pressure nodes at the open ends, i.e., I λ/2=L_{d}. The longitudinal modes for which I is odd may have a pressure anti-node at the duct's midpoint. The longitudinal modes for which I is even may have a pressure node at the midpoint of duct 110 and may be antisymmetric about the mid-plane.

The antisymmetric nodes may not couple efficiently to an axial laser excitation because the overlap integral contains equal positive and negative phases of the wave function that cancel out. The integral then vanishes. Conversely, the overlap integral for the symmetric modes (odd I) does not vanish; it decreases in proportion to 1/I.

The lowest-order symmetric mode (I=1) has the largest overlap integral and, therefore, the most efficient coupling to the laser excitation. The lowest-order symmetric mode will be designated herein as S1 and will be used for PAS measurements. The second symmetric mode, S2 (I=3), may be used to study the frequency-dependent molecular relaxation effects. The S1 and S2 modes are sometimes referred to herein as the PAS modes.

Resonance frequencies may be perturbed from those of an open-ended, half-wave resonator by an amount proportional to A_{d}/A_{c}≈0.04, where A_{d} is the cross-sectional area of duct 110, and A_{c} is the cross-sectional area of the either chamber 120 or 130. Because the chambers 120, 130 have low acoustic impedances, at either end of the duct 110 they act as buffers that reduce the background signal from absorption by the windows, and they reduce the perturbation from the inlet and outlet ports. The ports may change the measured acoustic pressure of the S1 mode by less than 55×10⁻⁶ p̅_{S1} and change its resonance frequency by less than 1×10⁻⁴ f_{S1}.

Sensitivity calibration for the electret microphone 140 may be performed under ambient conditions against a microphone, e.g., the commercially available Bruel and Kjaer (B&K) type 4138, ⅛ inch condenser microphone. The calibration of the condenser microphone may be checked against another instrument, e.g., a B&K, type 4228 pistonphone. Both the electret 140 and condenser microphone may be mounted in a small acoustic coupler with a B&K, type 4136, ¼ inch microphone cartridge used as a frequency-doubling sound source. The sensitivity of the electret microphone 140 may be measured under similar conditions for which the O₂ A-band measurements were obtained. These conditions included a temperature and pressure of a certain temperature and pressure as well as a relative humidity (RH≈40%).

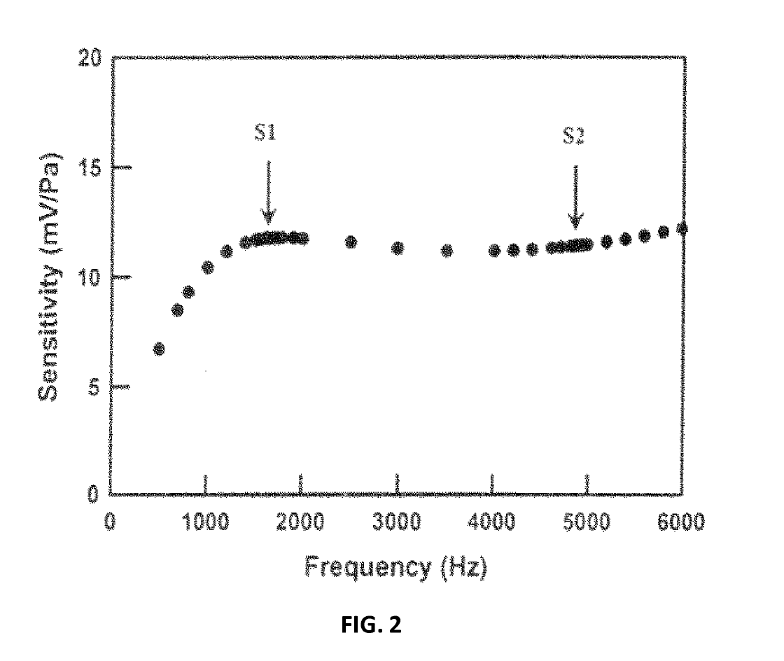

Referring now to FIG. 2, illustrated is the measured sensitivity of the electret microphone 140 under ambient conditions. The dependence of the microphone sensitivity on relative humidity was also measured. Under the conditions of CO₂ measurements with relative humidity at 28%, the microphone sensitivity may be lower than the calibration, e.g., 1.3% below.

The acoustic response of the photoacoustic cell may be measured with one optical window replaced by a sound source. The sound source may include a piezoceramic disc (lead zirconate titanate, PZT) attached to a diaphragm that may be mounted on an endplate flange.

A radial strain may develop within the PZT disk in response to an applied voltage from a function generator e.g., a Stanford Research® DS345. This radial strain may cause the diaphragm to bend.

A dual phase lock-in amplifier, e.g., a Stanford Research Systems® SR830, may measure the synchronous output signal from the microphone. At each frequency, the in-phase component μ and the quadrature component υ of the microphone signal may be recorded and referenced to the function generator.

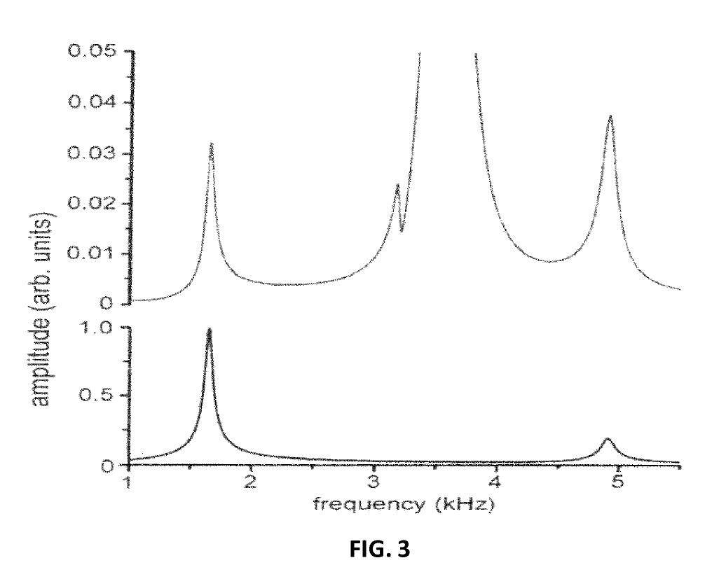

Referring now to FIG. 3, illustrated is the absolute magnitude of the measured acoustic spectrum up to 5 kHz when the cell was filled with ambient air. The top panel of FIG. 3 shows a measured response of a photoacoustic cell to excitation by a piezoelectric transducer (PZT) source. The bottom panel shows a measured response to laser excitation, illustrating the S1 and S2 PAS modes near 1.6 kHz and 4.8 kHz. The laser excitation does not efficiently couple to the modes between 3 kHz and 4 kHz. The S1 and S2 modes may be well isolated from other modes. The measured photoacoustic spectrum is also shown in FIG. 3. The insensitivity of the PA signal to the anti-symmetric mode around 3600 Hz compared to the signal from the PZT source is remarkable. In the vicinity of each mode (f, −2g≦f≦f, +2g), the data may be fit with the resonance response function which may be expressed as follows:

$$u + i 𝓊 = \frac{if 𝒶}{{( {f}_{i} + i g )}^{2} - {f}^{2}} + ℬ + 𝒞 ( f - \overline{f} ) . \qquad ( Equation 1 )$$

The resonance frequency f₁, the half-width g, the complex amplitude d, and the complex background parameters [symbol] and [symbol] may be adjusted parameters. The background terms may account for the tails of other modes, frequency dependence of the transducers, cross talk, etc. The linear background term was included only if it was justified by an F-test at the 95% level. The parameter f̅ was not adjusted but was defined as the midpoint between the lowest and highest frequency in the data set.

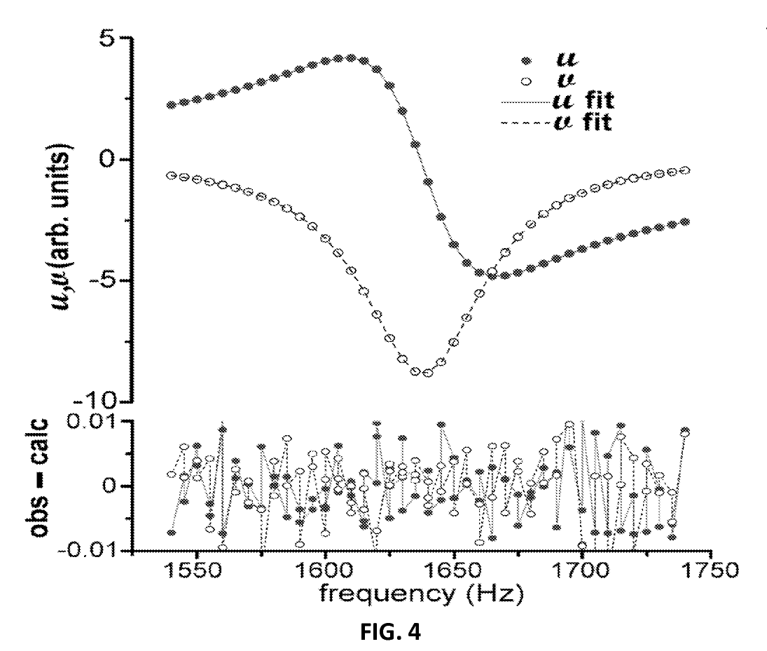

Referring now to FIG. 4, illustrated is an example of the measured response of the S1 mode in air at 100 kPa and the deviations from the 8-parameter fit. Here, shown is the response from the lock-in amplifier. The symbol u represents an in phase signal and v represents an out of phase signal.

The resonance frequencies and half widths in air and in nitrogen were measured with this technique as a function of pressure between 17 kPa and 100 kPa. The signal-to-noise ratio may be expressed as |vₘₐₓ|/σᵥ, where vₘₐₓ is the absolute magnitude of the signal at resonance and σᵥ is the RMS deviation from the fit, ranged from 160 at 17 kPa to 2000 at 100 kPa. A summary of the gas properties may be found in Table 1.

TABLE 1
Gas properties at 300 K and 0.101325 MPa pressure

| Gas | M (kg/mol) | P (kg/m) | γ | β_{ρ}T | c_{s (m/s)} | D_{1 (m}²_{/s)} | Pᵣ |
|---|---|---|---|---|---|---|---|
| N₂ | 28.013 | 1.1381 | 1.4012 | 1.0025 | 353.16 | 2.1919 × 10⁻⁵ | 0.7174 |
| O₂ | 31.999 | 1.3007 | 1.3965 | 1.0032 | 329.72 | 2.2136 × 10⁻⁵ | 0.7173 |
| Dry | 28.966 | 1.1770 | 1.4017 | 1.0027 | 347.32 | 2.1936 × 10⁻⁵ | 0.7196 |
| air¹ | | | | | | | |
| Wet | 28.856 | 1.1726 | 1.4009 | 1.0028 | 47.86 | 2.1900 × 10⁻⁵ | 0.7235 |
| air² | | | | | | | |

¹The molecular composition of dry air is defined as N₂ (0.78084), O₂ (0.20946), Ar (0.00934), CO₂(383 ppm)
²Wet air is defined as dry air with 1% H₂O. The molar composition o f wet air is assumed to be N₂ (0.77303), O₂(0.20736), Ar(0.009246), CO₂(379 ppm), H₂O(0.01), Dᵥ and D₁ were estimated assuming the viscosity and thermal conductivity are the same as dry air.

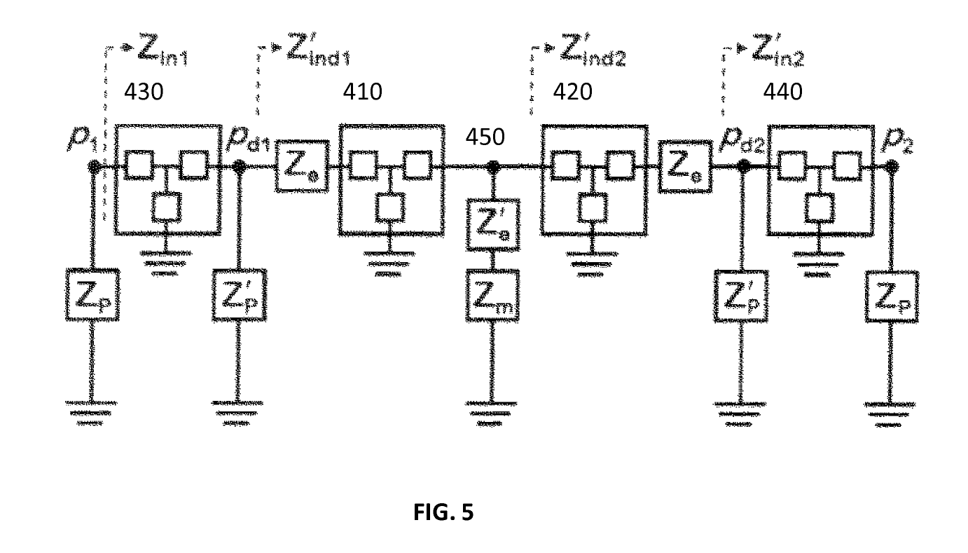

Referring back to FIG. 1, the acoustic embodiment for the photoacoustic resonator spectrometer may be called a lumped-element acoustic circuit. The embodiment shown in FIG. 1 includes a main duct divided into a first half duct 410 and a second half duct 420, chambers 430, 440, junction 450 between the chambers 430, 440 and duct (end effects) 4110, 420, and the microphone. The elements include the dissipation effect from thermal and viscous boundary layers adjacent to the wall. The chambers 430, 440 and main duct 410, 420 may be modeled as lossy transmission lines, represented by T-networks in the circuit diagram of FIG. 5.

The elements of the T-network may account for the viscous and thermal dissipation at the wall of a circular duct in terms of a complex propagation constant r, and a characteristic impedance Z₀ₓ, where x is either “c” or “d” for the chamber or duct, respectively.

In each chamber, the thermal boundary layer on the endplate and on the opposite wall at the junction with the main duct may be modeled as acoustic admittances Yₚ=1/Zₚ and Y′ₚ=1/Zₚ, respectively. Additional inertial and dissipative effects because of the divergent flow at the ends of the duct half-portions may be included in impedance Zₑ, which may be responsible for the familiar effective length correction. The impedance of Zₘ which may be represented by an inertance due to orifice opening, a compliance due to effective volume, and a resistance due to internal energy losses. This model may be used to estimate the resonance frequencies and half-widths.

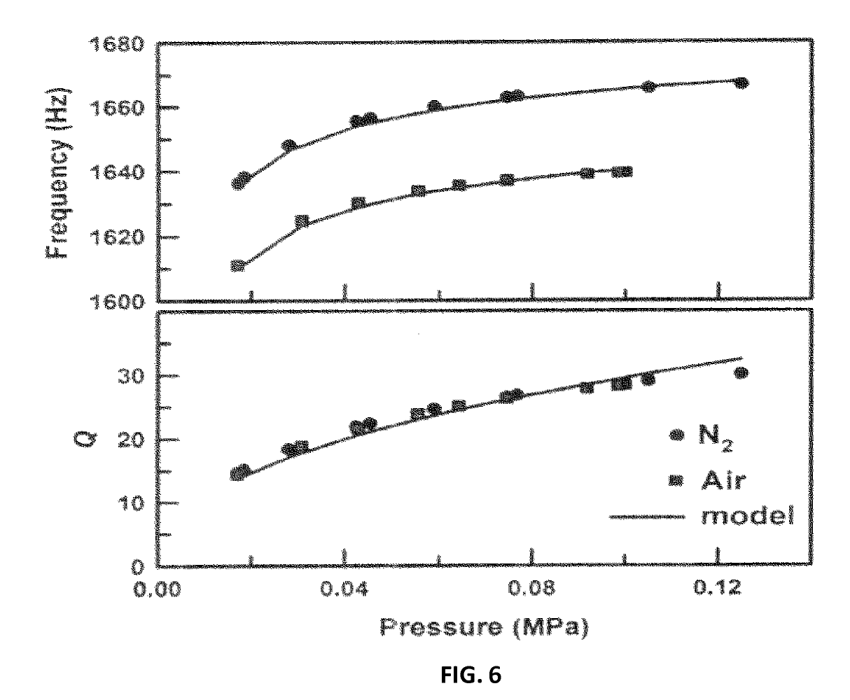

Referring now to FIG. 6, the measured and estimated resonance frequencies and quality factors for air and dry nitrogen are shown. The measured and modeled resonance frequencies are shown in the top graph while the quality factors are shown in the bottom graph. Both graphs relate to the S1 mode when the resonator was filled with nitrogen or air at 300K as a function of pressure.

The overlap integral may be approximated using the velocity potential in the limit of no boundary layer. The coefficient of the leading fractional correction due to the boundary layer may be estimated to be of the order 1×10⁻⁵ for the resonator described hereinabove. Velocity potential for PAS modes in this limit may, in each of the resonator's four sections (two chambers and two half ducts), be described as follows:

φ(z)=B cos(kz+φ) (Equation 2)

The velocity potential is as follows:

$$\begin{matrix}{ϕ}_{c} ( z ) = {B}_{c} cos [ k ( \vert z \vert - \frac{1}{2} {L}_{d} - {L}_{c} ) ] , \\ \frac{1}{2} {L}_{d} \leq \vert z \vert \leq \frac{1}{2} {L}_{d} + {L}_{c} & ( Equation 3 ) \\ {ϕ}_{d} ( z ) = {B}_{d} cos ( k \vert z \vert + φ ) , \\ 0 \leq \vert z \vert \leq \frac{1}{2} {L}_{d} & ( Equation 4 )\end{matrix}$$

The boundary conditions on φ(z) may be described as follows:

$$\begin{matrix}\frac{d {ϕ}_{c}}{d z} = 0 , \\ at z = \pm \frac{1}{2} {L}_{d} \pm {L}_{c} & ( Equation 5 ) \\ \frac{- {iωρϕ}_{c}}{{A}_{c} d {ϕ}_{c} / d z} - \frac{- {iωρϕ}_{d}}{{A}_{d} d {ϕ}_{d} / d z} = ∓ {Z}_{e} , \\ at z = \pm \frac{1}{2} {L}_{d} & ( Equation 6 ) \\ \frac{d {ϕ}_{d}}{d z} = \frac{{ρωϕ}_{d}}{2 i {A}_{d} {Z}_{m}} , \\ at z = 0 , & ( Equation 7 )\end{matrix}$$

where Zₑ=iρωδ₁/A_{d} (neglecting dissipation) and δ₁ is the inertial length correction. The velocity potential as defined by equations 3 and 4 hereinabove is consistent with the boundary conditions if the parameters k, φ, B_{c} and B_{D} satisfy the following relationships:

$$\begin{matrix}tan ( φ ) = \frac{ρ c}{2 i {A}_{d} {Z}_{m}} & ( Equation 8 ) \\ \frac{{A}_{d}}{{A}_{c}} cot ( {kL}_{c} ) + cot ( \frac{1}{2} {kL}_{d} + φ ) = k {δ}_{1} & ( Equation 9 ) \\ \frac{{B}_{c}}{{B}_{d}} = - \frac{{A}_{d} sin ( \frac{1}{2} {kL}_{d} + φ )}{{A}_{c} sin ( {kL}_{c} )} & ( Equation 10 )\end{matrix}$$

The overlap integral may be evaluated analytically to obtain the following:

$$\frac{L}{V} {𝒢}_{S 1} \approx ( 4.161 \pm 0.009 ) \times {10}^{4} {m}^{- 2} . \qquad ( Equation 11 )$$

The uncertainty given in the above-referenced equation may be dominated by the uncertainty of microphone impedance (˜0.2%) and the uncertainty of the inertial length correction (˜0.1%).

The O₂ A-band may be centered at wave number v̅=13122 cm⁻¹, and may contain transitions within the b¹Σ⁺←X³Σ⁻(0←0) band of molecular oxygen. This band may play an important role in near-infrared absorption in the Earth's atmosphere. This band may be used for ground-based and satellite-based measurements of atmospheric gases. Regarding the relatively weak and spectrally isolated O₂ magnetic-dipole A-band transitions, these may have line intensities of the order 10⁻²³ cm molec⁻¹ and may be about 10⁷ times weaker than typical near-infrared electric dipole transitions. The O₂ A-band is important to atmospheric science and remote sensing. Its line parameters (positions, intensities and line shape coefficients) have been extensively measured. Updated O₂ A-band line parameters are archived in the 2008 version of the HITRAN (high-resolution transmission) molecular spectroscopic database. These line intensities have relative uncertainties <0.5%, making them an attractive reference values. Referring now to Table II, summarized are the O₂ A-band lines that may be probed. Line parameters for the ¹⁶O₂ transitions probed were as follows: zero pressure wave number v̅ₒ, lower state energy E″, FWHM Doppler width δv_{D} (Tₜ=296K), reference line intensity S_{HT} (Tₜ=296K), line broadening and narrowing coefficients γₐᵢᵣ, γ_{self} and γₙₐᵣ.

| | \tilde{v}_{D} | E″/hc | S_{HT} | δv_{D} | γₐᵢᵣ | γₙₐᵣ | n_{γ} |
|---|---|---|---|---|---|---|---|
| Transition | (cm⁻¹) | (cm⁻¹) | (cm/molec) | (GHz) | (MHz/Pa) | (MHz/Pa) | (10⁻³) |
| ^{P}P(9) | 13091.7104 | 130.4375 | 8.298 × 10⁻²⁴ | 0.85495 | 0.0146 | 0.0030 | 0.74 |
| ^{P}Q(9) | 13093.6558 | 128.4921 | 7.276 × 10⁻²⁴ | 0.85508 | 0.0146 | 0.0030 | 0.74 |
| ^{P}P(11) | 13084.2035 | 190.7748 | 7.435 × 10⁻²⁴ | 0.85446 | 0.0141 | 0.0038 | 0.72 |
| ^{P}Q(11) | 13086.1252 | 188.8531 | 6.683 × 10⁻²⁴ | 0.85459 | 0.0141 | 0.0024 | 0.73 |

The photoacoustic spectrometer of the present disclosure has a calculated and measured cell constant that differ by about one percent (1%), provided all relevant relaxation mechanism are properly taken into account. The cell constant may be expressed as follows:

$${C}_{si} = \frac{{\overline{p}}_{S 1} ( {r}_{m} )}{{ℛ}_{S 1} α {W}_{0}} \approx \frac{γ - 1}{{β}_{P} T} \frac{{Q}_{S 1} {𝒢}_{S 1} L}{2 π {f}_{S 1} V} , \qquad ( Equation 12 )$$

Two aspects of the photoacoustic cell make it amenable to modeling. For example, the system is significantly axially symmetrical, with planar windows and baffles. Also, the inlet and exit tubes may be relatively small and located near nodal planes, thus promoting turbulent gas-mixing and minimizing its impact on the cell constant.

The photoacoustic spectrometer of the present disclosure may also be beneficial for situations where the microphone design varies slightly. In addition, it may be beneficial for measuring the absorption coefficient in unknown samples, including aerosols, because it may accurately predict the photoacoustic cell constant. Unlike some other systems, the photoacoustic spectrometer system of the present disclosure does not involve hazardous compounds, difficult sample preparation, difficult-to-access spectral regions or species with uncertain absorption cross sections. The photoacoustic spectrometer of the present disclosure may also be good for high-resolution line shape measurements.

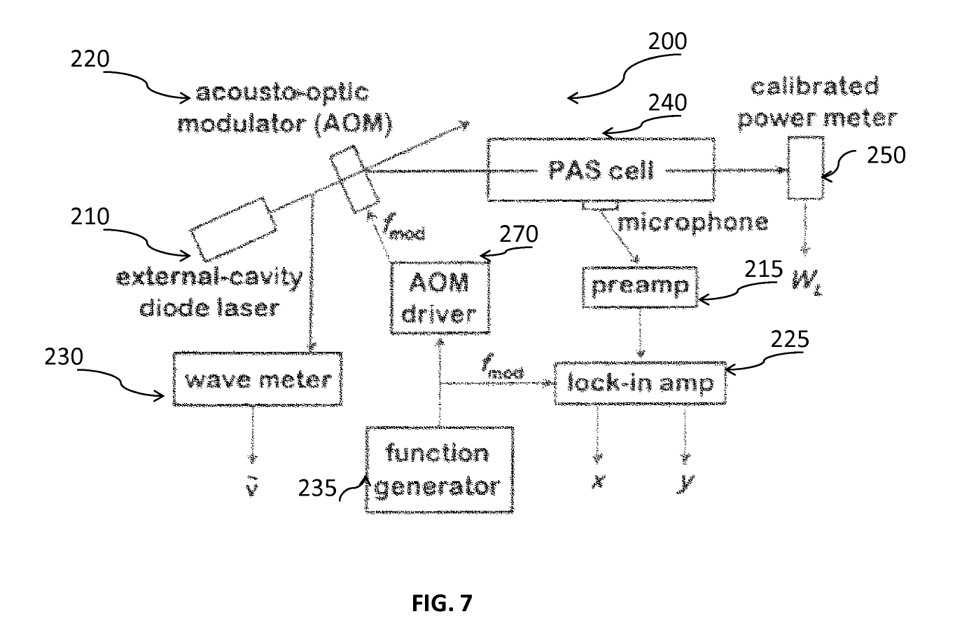

Referring now to FIG. 7, illustrated is a PAS system in accordance with one embodiment of the present disclosure. The PAS system 200 includes a light source 210, an acousto-optic intensity modulator 220, an acousto-optic modulator driver 270, a wavelength meter 230, a photoacoustic cell 240, a power meter 250, a two-channel phase-sensitive lock-in amplifier 260, and a function generator 280. The system 200 also includes a data acquisition system (not shown).

The light source 210 may be an external-cavity diode laser (ECDL) and may emit up to 10 mW in the wavelength range 759 nanometers (nm) to 770 nm. The light source 210 may provide a single-mode laser beam having less than 1 megahertz (MHz) short-term line width with mode-hop-free tuning over the entire wavelength range. Fine tuning of the ECDL 210 may be actuated by an external computer that uses a piezoelectric-actuated mirror having a full range of 60 gigahertz (GHz).

The absorbed laser power may be coupled into acoustic resonances. This may be done by first, intensity modulating the laser beam using an acousto-optic modulator (AOM) 220 and secondly, directing the first-order diffracted beam (which may be about 2.5 mW peak-to-peak) from light source 210 to the photoacoustic cell 240. The acousto-optic modulator driver 270 may operate at a carrier frequency of 80 MHz and may be amplitude modulated at frequency f_{mod} using function generator 235. Fourier analysis of the modulated laser intensity may reveal that the acousto-optic modulator 220 provides a near-perfect sinusoidal waveform at f_{mod} with constant efficiency over the frequency range of interest. Unlike photoacoustic current-modulation schemes that use distributed feedback lasers, the acousto-optic modulator 220 of the present disclosure introduces no residual wavelength modulation of the source laser. (Current modulation of some lasers may produce sinusoidal output with little or no residual wavelength modulation, in which case the AOM would not be needed.) The lock-in amplifier 225, which was referenced to f_{mod}, may provide both in-phase and out-of-phase signals with time constant set to 10 ms. The AOM 220 is optional if current control of diode laser intensity produces sinusoidal modulation with little or no wavelength modulation. This is possible with some lasers. Moreover, an alternative way of determining the wavenumber scale without using a wavemeter is to observe two (2) or three (3) well known spectroscopic lines and deducing the wavenumber scale from these measurements.

A power meter 250 may measure the beam power exiting the photoacoustic cell 240. Spectra may be recorded by step scanning the laser and then sampling the wavelength meter 230, lock-in amplifier outputs and power meter 250. To compensate for the finite frequency response of the power meter 250, the peak-to-peak beam power at the beginning of each scan may be measured with f_{mod} set at 10 Hz. This beam power measurement may provide an absolute scaling factor for subsequent power measurements taken at higher modulation frequencies. The outputs for the lock-in amplifier 225 and power meter 250 may be recorded using a multi-channel 18-bit digitizer at 10⁵ samples per second, enabling an ensemble of k values to be obtained every 0.1 second. At each wave number step of the laser, k values of the observed quantities may be averaged. The optimal averaging time may be found by evaluating the Allan variance of the photoacoustic signal.

The sample pressure may be measured using a capacitance diaphragm gage, and a thermistor mounted on the wall of photoacoustic cell 240 for monitoring sample temperature. A multimeter in four-wire mode may measure the thermistor resistance. For atmospheric air samples, the relative humidity may be measured to calculate the O₂ molar fraction assuming a dry gas molar fraction of e.g., 20.947%. The dry O₂ may be humidified and the humidity content measured at the output of the chamber of photoacoustic cell 240. Relative humidity of the atmospheric pressure sample air streams may be in the range of 2% to 90%.

While the specification describes particular embodiments of the present invention, those of ordinary skill can devise variations of the present invention without departing from the inventive concept.

We claim:

1. A photoacoustic spectrometer for quantitative absorption measurements of pure gases, gaseous mixtures and aerosols, comprising:
a central duct having a length, a diameter, and an axis of symmetry along its length;
two substantially identical cylindrical chambers configured to receive a gas, gaseous mixture or aerosol, each of said chambers having a length and a diameter, each of said chambers being positioned at the end of said central duct and connected to each other by the central duct, wherein the length of each said chambers is substantially equal to half the length of the central duct, the chambers being axially symmetrical about the axis of symmetry for the central duct;
an optical element mounted axially on an outer wall of each said two chambers;
a microphone, positioned in the duct substantially midway between the two chambers, the microphone being configured to measure an acoustic response of a gas, gaseous mixture or aerosol when said gas, gaseous mixture or aerosol is disposed within the chambers and duct; and
an inlet tube extending from one of said two chambers, and an exit tube extending from the other of said two chambers, each of the inlet tube and exit tube being positioned at substantially the location of an acoustic pressure node.

2. The photoacoustic spectrometer of claim 1, wherein the optical element is an optical planar window or a partially reflecting mirror.

3. The photoacoustic spectrometer of claim 1, wherein the spectrometer is capable of at least two symmetric modes.

4. A laser-driven and acoustically resonant photoacoustic spectrometer system, comprising:
a light source configured to emit light;
a photoacoustic cell having:
a central duct having a length, a diameter, and an axis of symmetry along its length;
two substantially identical cylindrical chambers configured to receive a gas, gaseous mixture or aerosol, each of said chambers having a length and a diameter, each of said chambers being positioned at the end of said central duct and connected to each other by the central duct, wherein the length of each said chambers is substantially equal to half the length of the central duct, the chambers being axially symmetrical about the axis of symmetry for the central duct;
an optical element mounted axially on an outer wall of each said two chambers;
an inlet tube extending from one of said two chambers, and an exit tube extending from the other of said two chambers, each of the inlet tube and exit tube being positioned at substantially the location of an acoustic pressure node; and
a microphone positioned within the duct substantially midway between the two chambers, the microphone being configured to measure an acoustic response of a gas, gaseous mixture or aerosol when said gas, gaseous mixture or aerosol is disposed within the chambers and duct.

5. The system of claim 4, further comprising:
an intensity modulating device configured to intensity modulate the light source and direct said intensity modulated light to the photoacoustic cell.

6. The system of claim 5, wherein the intensity modulating device includes:
an acousto-optic modulator device configured to intensity modulate the laser beam and direct the first-diffracted beam to the photoacoustic cell; and
an acousto-optic driver.

7. The system of claim 4, further comprising:
a lock-in amplifier configured to measure the output from the microphone.

8. The system of claim 4, further comprising:
a function generator configured to produce a sine wave for intensity modulating the light source.

9. The system of claim 4, further comprising:
a recording mechanism configured to record spectra; and
a power meter configured to measure the beam power exiting the photoacoustic cell.

10. The system of claim 4, wherein the light source includes an external-cavity diode laser.

11. The system of claim 4, further comprising:
a wavelength meter device configured to measure the laser wave number of the light emitted from the light source;

12. A method for measuring the absolute response of a laser-driven, intensity modulated photoacoustic spectrometer, comprising the steps of:
emitting a laser beam from a light source;
providing a photoacoustic cell that includes:
a central duct having a length, a diameter, and an axis of symmetry along its length;
two substantially identical cylindrical chambers configured to receive a gas, gaseous mixture or aerosol, each of said chambers having a length and a diameter, each of said chambers being positioned at the end of said central duct and connected to each other by the central duct, wherein the length of each said chambers is substantially equal to half the length of the central duct, the chambers being axially symmetrical about the axis of symmetry for the central duct;
an optical element mounted axially on an outer wall of each said two chambers; and
an inlet tube extending from one of said two chambers, and an exit tube extending from the other of said two chambers, each of the inlet tube and exit tube being positioned at substantially the location of an acoustic pressure node;
intensity modulating the laser beam and directing the beam to the photoacoustic cell;
recording spectra from the laser beam;
measuring the beam power exiting the photoacoustic cell; and
calculating and measuring the absolute response of the photoacoustic cell.

13. The method of claim 12, further comprising:
measuring the laser wavenumber of the laser beam emitted from the light source.

14. The method of claim 12, further comprising:
prior to the intensity modulating step, generating a reference sine wave.
